(19) United States
(12) Patent Application Publication
(10) Pub. No.: US 2026/0281925 A1
(43) Pub. Date: Sep. 17, 2026

(54) METHODS AND APPARATUSES FOR USING SIDELINK RESERVED RESOURCES TO DETERMINE ONE OR MORE RB SETS FOR SSB TRANSMISSION

(71) Applicant: InterDigital Patent Holdings, Inc., Wilmington, DE (US)

(72) Inventors: Aata El Hamss, Laval (CA); Moon IL Lee, Melville, NY (US); Tuong Hoang, Montreal (CA); Tao Deng, New York, NY (US)

(73) Assignee: InterDigital Patent Holdings, Inc., Wilmington, DE (US)

(21) Appl. No.: 19/162,723

(22) PCT Filed: Apr. 3, 2024
(86) PCT No.: PCT/US2024/022854

§ 371 Date: Sep. 5, 2025

Related U.S. Application Data
(60) Provisional application No. 63/456,900, filed on Apr. 4, 2023.

(51) Int. Cl. H04W 56/00; H04W 72/40

(52) U.S. Cl. CPC H04W 56/0015; H04W 72/40

(57) ABSTRACT

A WTRU may monitor sidelink transmissions from one or more other WTRUs during a resource sensing window, and determine reserved sidelink resources prior to or after sidelink synchronization signal block (S-SSB) slots based on the monitored sidelink transmissions during the resource sensing window. The S-S-SSB slots may include a plurality of RB sets, and at least one RB set of the plurality of RB sets may be configured as a default RB set. The WTRU may determine one or more other WTRUs reserving the reserved sidelink resources, for example, based on identification information associated with the one or more other WTRUs. The WTRU may transmit the S-SSB information on at least one RB set other than the default RB set based on at least one of the one or more other WTRUs reserving the reserved sidelink resources on a slot prior to or after the S-SSB slots.

### CROSS-REFERENCE TO RELATED APPLICATIONS

This application claims the benefit of U.S. Provisional Patent Application No. 63/456,900, filed Apr. 4, 2023, the disclosure of which is incorporated herein by reference in its entirety.

### BACKGROUND

Unlicensed spectrum is frequency resources that are free to use by different operators and possibly with different radio technologies. The transmitters may transmit on unlicensed spectrum if channel access succeeded i.e., listen before talk (LBT) succeeded. When LBT fails, the transmitter back off for a certain duration and attempt to access the channel at later occasion. The transmitter keeps trying until the channel is idle. This procedure may cause delays for transmission and add some uncertainty on when a transmission will successfully be delivered.

Sidelink synchronization signal block (S-SSB) may be transmitted in sidelink channels to provide synchronization to a sidelink wireless transmit/receive unit (WTRU) that is out of the coverage or in cell edge. A synchronization reference (sync ref) WTRU may be a sidelink WTRU that transmits S-SSB in sidelink channels. Other sidelink WTRUs monitor S-SSB to acquire the synchronization. In the existing 5G new radio (NR) and 3GPP Long term Evolution (LTE) sidelink systems, S-SSB resources are separately configured from the resource pool and cannot be used for sidelink data transmission.

With the support of sidelink in unlicensed channels and the uncertainty of accessing the channel, additional S-SSB transmission occasions may be configured to increase the chance of transmitting S-SSB and to enhance the sidelink synchronization performance. The additional S-SSB resources may be configured as part of the resource pool i.e., the additional S-SSB resource may be used for sidelink data opportunistically if they are not used by S-SSB transmission. Another option may be to separately configure from the resource pool i.e., the additional S-SSB resources cannot be used for sidelink data transmission.

### SUMMARY

In embodiments, a WTRU may be configured to perform a method for synchronization of a sidelink communications by transmitting sidelink synchronization signal block (S-SSB) information on one or more S-SSB slots. The S-SSB information includes multiple resource block (RB) sets, with at least one RB set configured as a default RB set. The WTRU monitors sidelink transmission from other WTRUs during a resource sensing window and determines the reserved sidelink resources prior to and/or after the S-SSB slots to identify the other WTRUs reserving sidelink resources. On the condition that at least one other WTRU has reserved sidelink resources either before or after the S-SSB slots, the WTRU may transmit the S-SSB on an RB set other than the default RB set. The WTRU may further determine a listen before talk (LBT) type for the S-SSB transmission on the RB sets.

A wireless transmit/receive unit (WTRU) may include a processor, memory, and/or a transceiver. The WTRU may be configured to monitor sidelink transmissions from one or more other WTRUs during a resource sensing window. The resource sensing window may be determined based on the S-SSB slots configuration. The WTRU may be configured to determine reserved sidelink resources prior to or after sidelink synchronization signal block (S-SSB) slots based on the monitored sidelink transmissions during the resource sensing window. The S-SSB slots may include a plurality of RB sets, and at least one RB set of the plurality of RB sets may be configured as a default RB set. The WTRU may determine one or more other WTRUs reserving the reserved sidelink resources, for example, based on the monitored sidelink transmissions during the resource sensing window. The WTRU may be configured to transmit the S-SSB information on at least one RB set other than the default RB set based on at least one of the one or more other WTRUs reserving the reserved sidelink resources on a slot prior to or after the S-SSB slots.

The WTRU may determine the at least one RB set other than the default RB set based on a priority associated with the reserved sidelink resources prior to or after the S-SSB slots. The WTRU may determine a listen before talk (LBT) type for the S-SSB transmission on the at least one RB set other than the default RB set. The LBT type could be a long LBT type or a short LBT type. The WTRU may be configured to send an indication of a listen before talk (LBT) type to be used for reserved sidelink transmission to the one or more other WTRUs. The indication to the other WTRUs may be sent via an indication physical sidelink broadcast channel (PSBCH).

The WTRU may monitor the sidelink transmissions during the resource sensing window to decode sidelink control information (SCI) transmitted by the one or more other WTRUs reserving the reserved sidelink resources. The SCI may indicate the reserved sidelink resources prior to or after the S-SSB slots. The WTRU may determine, based on the SCI, identification information of the one or more other WTRUs reserving the reserved sidelink resources in the slot before and after the S-SSB slots. For example, the WTRU may determine the at least one RB set other than the default RB set based on the identification information of the one or more other WTRUs reserving the reserved sidelink resources in the slot before and after the S-SSB slots.

A method performed by a WTRU (a Sync Ref WTRU and/or transmit WTRU) may also be described herein.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a flowchart showing an example of a synchronization reference (Sync ref) WTRU using reserved sidelink (SL) resources to determine the resource block (RB) sets for SSB transmission.

FIG. 3 is a diagram showing the transmitting (Tx) WTRU initiating a channel occupancy time (COT) on two RB sets overlapping with the S-SSB slots.

FIG. 4 is a flowchart showing an example of a Tx WTRU identifying a sync ref WTRU and requesting S-SSB transmission on multiple RB sets.

FIG. 5 is a flowchart showing an example procedure for a Sync ref UE indicating the used RB sets to transmit S-SSB.

### DETAILED DESCRIPTION

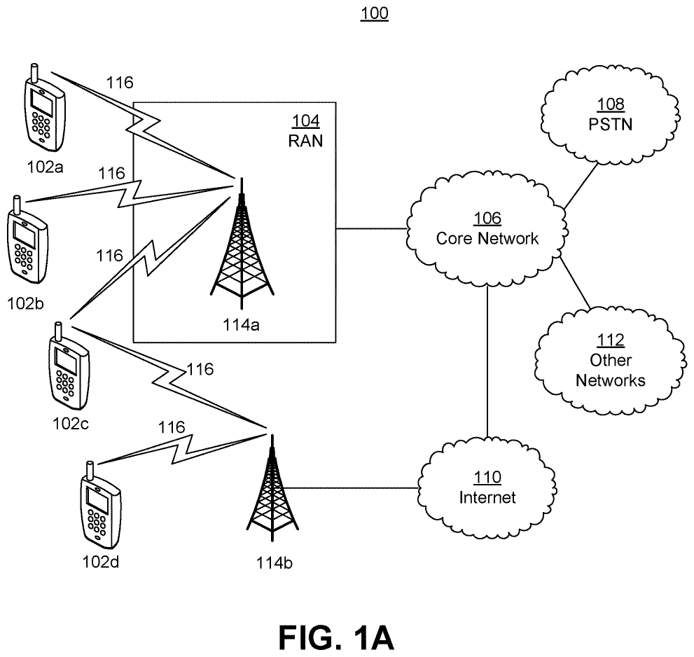

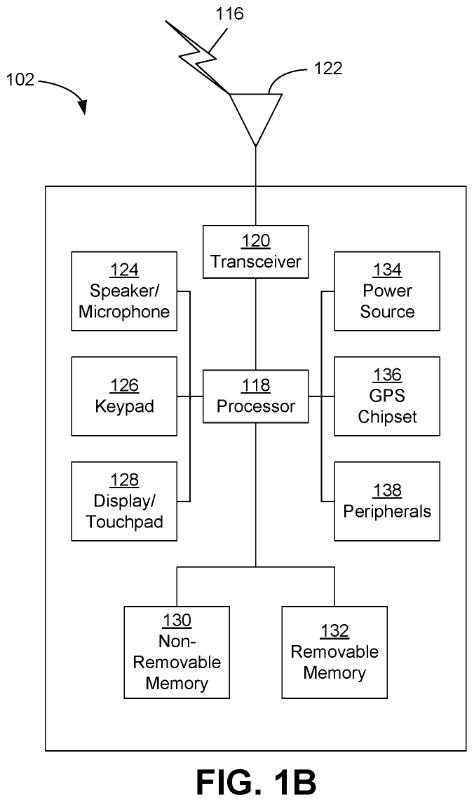

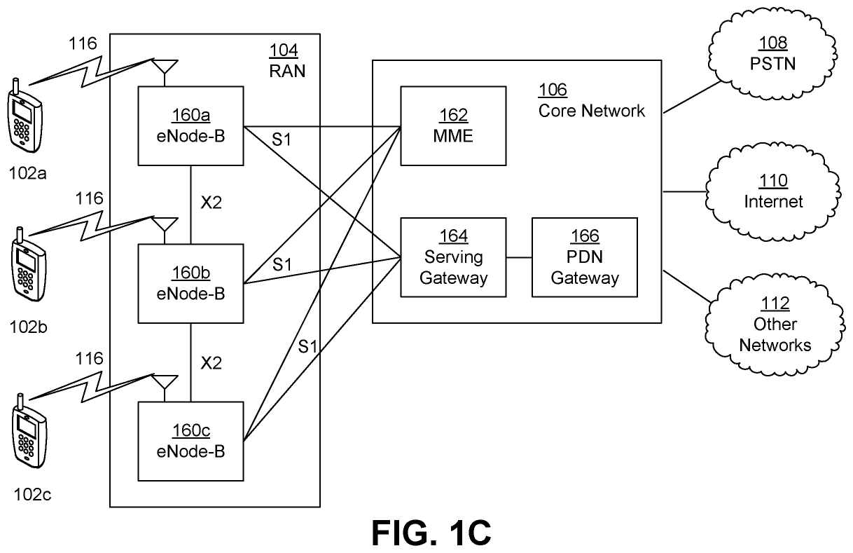

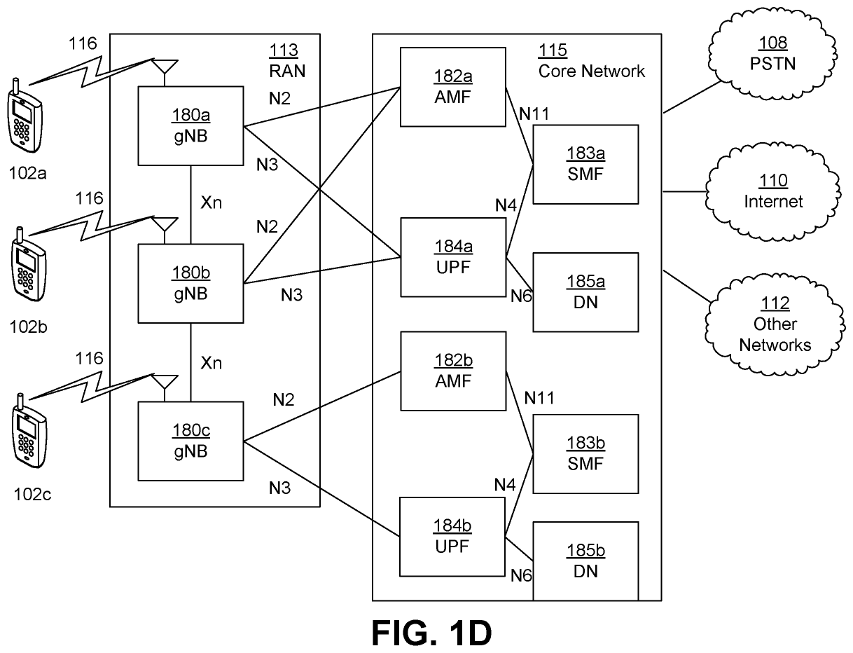

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUS 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANS, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive radio front end (RF) signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (UL) (e.g., for transmission) and downlink (DL) (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when downlink (DL) data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAS that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11 ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHZ depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency communication (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In wideband operation, a bandwidth configured for sidelink unlicensed spectrum may have multiple 20 MHz sub-bands, where each 20 MHz sub-band is called a RB set. When using wideband operation, a S-SSB may be transmitted using one RB set or using multiple RB sets (e.g., using repetition across different RB sets)

If S-SSB transmission is not configured as part of resource pool and a WTRU's initiated COT overlaps with S-SSB slot(s), the COT may be lost if the sync ref WTRU is not transmitting S-SSB as part of the COT to hold the initiated COT. Always transmitting the S-SSB in all the RB sets may not imply the COT is maintained (the S-SSB transmission typically uses LBT type 2 and the sync ref WTRU will typically be nearby the COT initiator). It is contemplated that there may be a problem in maintaining the COT using S-SSB transmission. Another problem may result from the S-SSB transmission being configured as part of resource pool. The issue relates to how the sidelink (SL) WTRU determines which of the RB set(s) is (are) being used for the S-SSB transmission to combine the multiple S-SSB transmission.

A sync ref WTRU may be a SL unlicensed (SL U) WTRU that transmits a sidelink synchronization signal block (S-SSB). A SL WTRU may be (pre)configured with one or more rules to determine whether and/or when to become a sync ref WTRU.

A SL U wideband may be a bandwidth that is configured for sidelink transmission on unlicensed spectrum and which has multiple 20 MHz sub-bands, where each 20 MHz sub-band is called an RB set.

A Tx WTRU may be a sidelink WTRU that has sidelink data and/or control information to transmit on one or more sidelink channels.

LBT type 1 may be a channel access type that requires sensing for random number of sensing slots, where the random number may be selected using a uniform distribution from duration that depends on the channel access priority. If the channel is sensed to be idle, the transmitter may start transmitting.

LBT type 2 may be a channel access type that requires sensing for fixed duration (either 16 us or 25 us) and starts transmitting if the channel is determined to be idle. Another sub-type of LBT type 2 may allow a transmitter to not sense the channel at all and to transmits without sensing.

A Sync ref WTRU may use one or more reserved SL resources to determine the RB set(s) for a SSB transmission. For example, the Sync ref WTRU may be configured to determine the one or more reserved SL resources during a sensing window. For instance, the sync ref WTRU may monitor sidelink transmissions from one or more other WTRUs during a resource sensing window. The sync ref WTRU may determine the RB set(s) to be used for transmission based on the determined one or more reserved SL resources before and after S-SSB slots. The S-SSB slots may include a plurality of RB sets. At least one RB set of the plurality of RB sets may be configured as a default RB set. he Sync ref WTRU may then hold the COT for other WTRUS.

A Default RB set configuration may be used for the S-SSB transmission. A sync ref WTRU may be configured to transmit a S-SSB in SL U wideband that consists of multiple RB sets. For example, a wideband may consist of RB set 0, RB set 1, . . . , RB set K. A sync ref WTRU may be configured to transmit S-SSB on a set of slots periodically (called S-SSB slots). Within the S-SSB slot(s), the sync ref WTRU may be configured to transmit S-SSB on a default RB set(s) e.g., RB set 0. In such case, the sync ref WTRU always transmits the S-SSB at least on the default RB set(s) e.g., sync ref WTRU always transmit S-SSB in S-SSB slots using RB set 0. For example, a sync ref WTRU is configured to transmit S-SSB on wideband that consists of 5 RB sets, and the default RB set is RB set 0. In this example, the sync ref WTRU always transmits S-SSB on RB set 0. In another example, the WTRU is configured with S-SSB default RB sets are RB set 0 and RB set 1. In this example, the sync ref WTRU always transmits S-SSB on RB set 0 and RB set 1.

A Sync ref WTRU may monitor one or more SL U transmissions. A WTRU may be configured to monitor sidelink unlicensed transmission, for example, after becoming a sync ref WTRU. The sync ref WTRU may start monitoring sidelink unlicensed transmission during a resource sensing window. Such resource sensing window may be determined based on the S-SSB slots configuration. The sync ref WTRU may be configured to start monitoring sidelink unlicensed transmissions in resource window sensing with length W_{sensing}slots/symbols and starting Tₛₜₐᵣₜslots/symbols prior to the S-SSB slot transmission. The configuration of W_{sensing} and Tₛₜₐᵣₜ may be per resource pool and/or bandwidth part. Additionally or alternatively, the values of W_{sensing} and Tₛₜₐᵣₜ may depend on the sync ref WTRU capability. For example, some sync ref WTRU with a first WTRU capability may have longer Tₛₜₐᵣₜ compared to sync ref WTRU with a second WTRU capability.

A Sync ref WTRU may determine one or more reserved SL U transmissions using resource sensing window. The sync ref WTRU may be configured to determine the reserved SL resources by monitoring a resource sensing window to decode sidelink control information (SCI) transmitted by the reserving WTRUs (e.g., WTRUs reserving sidelink transmissions). For example, SCI transmitted by other WTRUs may indicate the sidelink resource reserved for future sidelink transmission. The sync ref WTRU determines the reserved sidelink resources in all the frequency resources of the wideband in the slot before the S-SSB slot(s) and the reserved sidelink resources in all the frequency resources of the wideband in the slot after the S-SSB slot(s). The sync ref WTRU may determine the WTRU-IDs of the WTRUs reserving sidelink resources in the slot(s) before and/or after S-SSB slot(s) using a WTRU-ID indicated in the SCI or a WTRU-ID provided in the COT sharing information message that may be transmitted in sidelink unlicensed spectrum. The sync ref WTRU may then determine the RB set(s) reserved by each reserving WTRU by determining the RB set where the reserved resources belong to.

For each WTRU reserving sidelink resources before the S-SSB slot, the sync ref WTRU may check whether the same WTRU is also reserving sidelink resources after the S-SSB slot. The sync ref WTRU may associate the RB set with one WTRU reserving sidelink unlicensed resources on that RB set. Alternatively, the sync ref WTRU may associate the RB set with one or more WTRUs reserving sidelink unlicensed resources on that RB set.

A Sync ref WTRU may determine the RB set(s) to use for S-SSB transmission based on one or more reserved SL U resources. For example, in addition to the default RB set(s), the sync ref WTRU may determine the RB set(s) to use for S-SSB transmission based on the reserved SL U resources before and/or after S-SSB slot(s). In examples, the sync ref WTRU may use RB set #j from the pre-configured RB set of wideband for S-SSB transmission in S-SSB slot in one or more of the following cases.

The sync ref WTRU may use RB set #j from the pre-configured RB set of wideband for S-SSB transmission in S-SSB slot when at least N1 WTRUs have reserved resources belonging to the RB set #j before S-SSB slot where the value of N1 may be configured by the network. The value of N1 may be equal to 1. For example, at least one WTRU have reserved resources belonging to the RB set #j before S-SSB slot. The sync ref WTRU may use RB set #j from the pre-configured RB set of wideband for S-SSB transmission in S-SSB slot when at least N2 WTRUs may have reserved resources belonging to the RB set #j after S-SSB slot where the value of N2 may be configured by the network. The value of N2 may be equal to 1. For example, at least one WTRU have reserved resources belonging to the RB set #j after S-SSB slot. The sync ref WTRU may use RB set #j from the pre-configured RB set of wideband for S-SSB transmission in S-SSB slot when at least N3 WTRUs have reserved resources belonging to the RB set #j before and after S-SSB transmission where the value of N may be configured by the network. The value of N3 may be equal to 1. For example, at least one WTRU have reserved resources belonging to the RB set #j before and after S-SSB slot.

In examples, a sync ref WTRU may be configured to prioritize among the reserved RB sets for S-SSB transmission based on the priority associated to the sidelink transmission within reserved RB sets. The sync ref WTRU may not be capable of transmitting S-SSB using all the determined RB sets (for example, the RB sets are not contiguous in frequency domain, and the sync ref WTRU is only capable of transmitting S-SSB using contiguous RB sets). The sync ref WTRU may select RB set(s) for S-SSB transmission if the RB set(s) are reserved by a SL WTRU for high priority transmission.

In examples, a sync ref WTRU may be configured to transmit S-SSB on an RB set(s) depending on the WTRU ID of the SL WTRU reserving the sidelink resources on that RB set(s). For example, a sync ref WTRU may be restricted to transmit S-SSB on an RB set if a SL WTRU reserved resources on that RB set and the reserved resources are for transmission to sync ref WTRU e.g., groupcast/broadcast transmissions intended to sync ref WTRU.

A Sync ref WTRU may determine the LBT type to use for S-SSB transmission on the selected RB set(s). Upon determining the RB set(s) to be used for S-SSB transmission, the sync ref WTRU may select the LBT type (e.g., short or long LBT) to use for S-SSB transmission using one or more RB sets. The sync ref WTRU may select LBT type 2 (e.g., short LBT) to use for S-SSB transmissions on RB set if a SL U WTRU reserved sidelink resources within the RB set on the slot prior to the S-SSB slot (e.g., sync ref WTRU shares initiated COT from the WTRU reserving the sidelink resources). The sync ref WTRU may further check whether the initiated COT is allowed for sharing the COT. For example, the sync ref WTRU may determine whether the maximum allowed duration of COT will be exceeded if S-SSB transmission is within the initiated COT. In case the maximum COT duration will be exceeded, the sync ref WTRU may use LBT type 1 to transmit S-SSB on one or more RB sets. The sync ref WTRU may select LBT type 1 (e.g., long LBT) to use for S-SSB transmissions on RB set if a SL U WTRU reserved sidelink resources within the RB set on the slot after to the S-SSB slot. The sync ref WTRU may use different LBT types on different RB sets when transmitting S-SSB on one or more RB sets.

A Sync ref WTRU may attempt to transmit a S-SSB on one or more of the selected RB sets. The sync ref WTRU may attempt to transmit the S-SSB on the selected RB set(s) and using the required LBT type (e.g., short LBT or long LBT). For example, the sync ref WTRU may use a short LBT (e.g., sensing the channel for fixed duration to determine whether the channel is idle) or use a long LBT (e.g., sensing the channel for randomly selected number of sensing slots, where the range of the random number of sensing slots depends on the channel access priority access). Upon determining the channel is idle during the sensing duration, the sync Ref WTRU may transmit a S-SSB by repeating the S-SSB over the identified RB sets.

A Sync ref WTRU may indicate the LBT type to use for reserved resources after S-SSB slot(s). The sync ref WTRU may indicate to the WTRUs reserving sidelink resources after the S-SSB slot(s) the LBT type to use when transmitting on the reserved resources after S-SSB slot(s). The sync ref WTRU may indicate to the WTRUs reserving sidelink resources to use LBT type 2 if the sync ref WTRU successfully transmitted S-SSB on the determined RB sets. The sync ref WTRU may use a physical sidelink broadcast channel (PSBCH), e.g., to indicate the WTRUs reserving sidelink resources to use Type 2 LBT. Additionally or alternatively, the WTRUs reserving sidelink resources may monitor S-SSB transmission on one or more RB sets to determine whether S-SSB was transmitted.

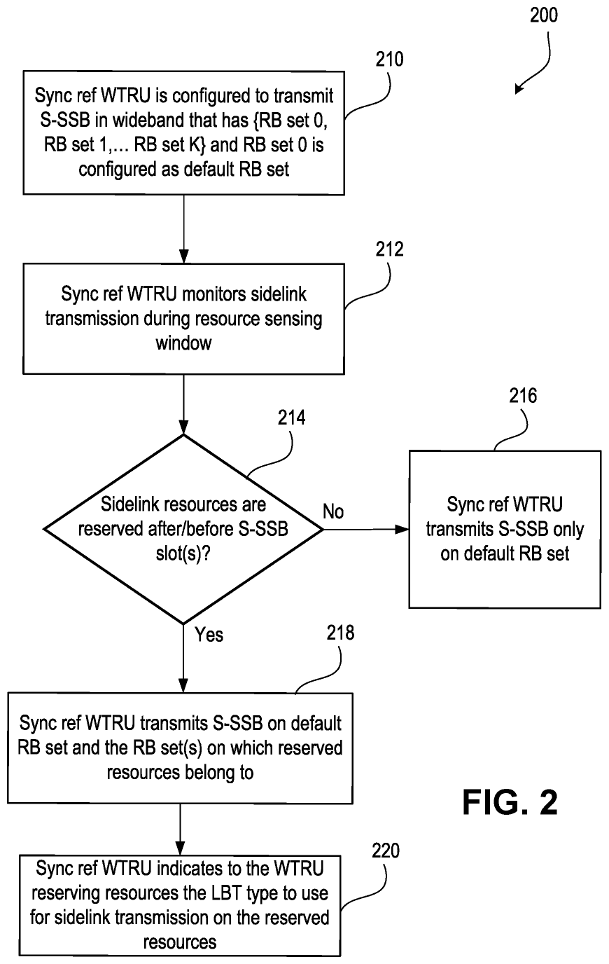

FIG. 2 is a flowchart depicting an example procedure 200 of a Sync ref WTRU using reserved SL resources to determine the RB sets for SSB transmission. The Sync ref WTRU may be configured to determine sidelink reserved resources during a sensing window. The sync ref WTRU may then determine the RB set(s) to be used for transmission based on the reserved resources before and after S-SSB slots. Sync ref WTRU may then hold the COT for other WTRUs.

At 210, the Sync ref WTRU may be configured to transmit a S-SSB on a wideband that consists of multiple RB sets (e.g., RB set 0, RB set 1, . . . , RB set K). One of the RB sets may be configured as the default RB set (e.g., RB set 0). The Sync ref WTRU may be configured to transmit S-SSB on S-SSB slot(s) (e.g., periodically transmits S-SSB on a set of slots). The Sync ref WTRU may further be configured to transmit (e.g., always transmit) on a default RB set (e.g., RB set 0) during S-SSB slot(s). At 212, the Sync ref WTRU may monitor one or more sidelink transmissions during a resource sensing window.

At 214, the Sync ref WTRU may determine the reserved sidelink resources prior to and/or after S-SSB slots. The Sync ref WTRU may identify the WTRU(s) reserving the sidelink resources. If the sidelink resources are reserved prior to and/or after the S-SSB slots, the sync ref WTRU may transmit the S-SSB on the default RB set (e.g., only the default RB set) at 216. If the reserved sidelink resources are not prior to and/or after the S-SSB slots, the Sync ref WTRU may transmit the S-SSBs on the default RB set and/or the RB set(s) on which reserved resources belong to, at 218. For example, in addition to the default RB set(s), the sync ref WTRU may attempt to transmit S-SSB on RB set j if one or more WTRU reserved sidelink resources on the slot before S-SSB slot(s) transmission within RB set j, and/or one or more WTRU reserved sidelink resources on the slot after S-SSB slot(s) transmission within RB set j. At 220, the Sync ref WTRU may determine the LBT type to use for S-SSB transmission on the determined RB set(s). For example, the Sync ref WTRU may determine whether to use Type 1 or Type 2 (e.g., long or short LBT) for S-SSB transmission on the determined RB set(s). The Sync ref WTRU may transmit a S-SSB on the identified RB sets using the determined LBT type. The Sync ref WTRU may indicate to the WTRUS reserving sidelink resources after S-SSB slot(s) the LBT type to use for reserved sidelink transmissions by using an indication PSBCH and/or having the WTRUs reserving sidelink resources after S-SSB slot(s) monitoring S-SSB transmission on one or more RB sets to determine whether S-SSB was transmitted.

A Tx WTRU may identify a sync ref WTRU and request S-SSB transmission on one or more RB sets. The Sync ref WTRU may indicate its WTRU ID. In examples, the sync ref WTRU may be configured to include its WTRU ID in a PSBCH message. Additionally or alternatively, the sync ref WTRU may indicate its WTRU ID using a sidelink secondary synchronization signal (S-SSS) and/or a sidelink primary synchronization signal (S-PSS) sequence. For example, a S-SSS/S-PSS sequence may be associated with a WTRU ID. Additionally or alternatively, a sync ref WTRU may indicate its WTRU ID using a PSBCH DMRS sequence. For example, a PBSCH DMRS sequence may be associated with a WTRU ID.

The Tx WTRU may determine the WTRU ID of one or more sync ref WTRU(s). For example, the Tx WTRU may be configured to monitor a S-SSB transmission to determine the WTRU ID of a sync ref WTRU. The Tx WTRU may monitor one or more sync ref WTRUs to determine their WTRU ID. The Tx WTRU may be configured with a communication range on which the Tx WTRU tries to identify sync ref WTRU(s). In some solutions, a Tx WTRU may be configured to identify sync ref WTRU using the WTRU ID included in the PSBCH message. Additionally or alternatively, a Tx WTRU may be configured to identify a sync ref WTRU using a S-SSS/S-PSS sequence. For example, a S-SSS/S-PSS sequence may be associated with a WTRU ID. Additionally or alternatively, a Tx WTRU may be configured to identify a sync ref WTRU using a PSBCH DMRS sequence. For example, a PBSCH DMRS sequence may be associated with WTRU ID.

The Tx WTRU may initiate a COT. For example, the Tx WTRU may determine the number of RB sets required for its data sidelink transmission in a slot(s) before S-SSB slot(s) transmission. For example, the Tx WTRU may be configured with a wideband operation which have 5 RB sets. Based on the sidelink data transmission of the Tx WTRU, the WTRU selects 3 RB sets to use for sidelink data transmission. The Tx WTRU may use LBT type 1 to initiate the COT on the select RB sets to transmit sidelink data transmission and sidelink control information.

The Tx WTRU may initiate that the COT overlaps with S-SSB slot(s). When initiating a COT, the Tx WTRU may determine whether its COT overlap with S-SSB slot(s). For example, the Tx WTRU may initiate a COT on slot n with duration of M slots. The Tx WTRU may determine that slot n+2 is configured for S-SSB transmission. Upon determining that its COT overlapping with S-SSB slots, the Tx WTRU may identify the set RB set(s) needed for sidelink data transmission after S-SSB slot(s). For example, the Tx WTRU may initiate a COT on 3 RB sets for sidelink data/control transmission on slot n. Tx WTRU may stop transmitting in slot n+2 configured for S-SSB transmission and may determine that 2 RB sets will be needed for sidelink data/control transmission after S-SSB slot(s).

The Tx WTRU may identify one or more RB sets needed after the S-SSB slot(s). For example, the Tx WTRU may determine the number of RB sets needed for sidelink data/control transmission after S-SSB slot(s) based on one or more of the Tx WTRU's buffer status, a maximum COT duration allowed for the initiated COT, a number of S-SSB slots, a number of initiated RB sets, or a GAP duration between the Tx WTRU's transmission end and starting of S-SSB slots. For example, the Tx WTRU may determine the number of RB sets needed for sidelink data/control transmission based on the buffer status and how many data should be transmitted and/or if the WTRU has large number of packets to be transmitted, the WTRU selects RB sets that are needed for the transmission. The Tx WTRU may determine that an RB set is needed for sidelink data/control transmission if transmitting on an RB set after the S-SSB slot(s) will not lead to exceed the allowed maximum COT duration. The Tx WTRU may determine if an RB set is needed for sidelink data/control transmission if transmitting the number of S-SSB slot(s) will not lead to exceed the allowed maximum COT duration. If the GAP duration between the Tx WTRU's transmission end and the starting of S-SSB slot(s) is below a configured threshold within an RB set, this RB set may be selected.

The Tx WTRU may select the sync ref WTRU to transmit the S-SSB slot(s) on multiple RB sets. Upon identified RB sets required for sidelink data/control transmission after S-SSB slot(s), the Tx WTRU may request the sync ref WTRU to transmit S-SSB on the identified RB set(s). The Tx WTRU may select a sync ref WTRU from the identified sync ref WTRUs based on one or more of the following. The Tx WTRU may select the Sync ref WTRU with the highest reference signal received power (RSRP) of the S-SSB, for example, when the Tx WTRU selects sync ref WTRU from the identified sync ref WTRUs with received S-SSB that has highest RSRP. The Tx WTRU may select the Sync ref WTRU with WTRU ID within a pre-configured WTRU IDs, for example, when the Tx WTRU selects sync ref WTRU from the identified sync ref WTRUs with an ID that belong to configured WTRU ID list. The Tx WTRU may select the Sync ref WTRU that is part of unicast communication with Tx WTRU, for example, when the Tx WTRU selects sync ref WTRU from the identified sync ref WTRUs that is transmitting unicast data to Tx WTRU. Additionally or alternatively, the Tx WTRU may select the sync ref WTRU from the identified sync ref WTRUS that is receiving unicast data from Tx WTRU. The Tx WTRU may select the Sync ref WTRU that is part of groupcast/broadcast communication with Tx WTRU, for example, when the Tx WTRU selects sync ref WTRU from the identified sync ref WTRUs with an ID that transmits groupcast transmission to the Tx WTRU. Additionally or alternatively, the Tx WTRU may select the sync ref WTRU from the identified sync ref WTRUs with an ID that receives groupcast transmission from the Tx WTRU.

The Tx WTRU may indicate to the selected sync ref WTRU to transmit S-SSB slot(s) on multiple RB sets. The TX WTRU may indicate to a selected sync ref WTRU the RB sets for S-SSB transmission in the S-SSB slots. If the Tx WTRU selected a sync ref WTRU that is target WTRU of a unicast/groupcast/broadcast transmission within the initiated COT, the Tx WTRU may use SCI to indicate to the sync ref WTRU the RB sets required for S-SSB transmission to hold the initiated COT. If the Tx WTRU selected a sync ref WTRU that is not a target WTRU of a unicast/groupcast/broadcast transmission within the initiated COT, the Tx WTRU may use a broadcasted COT sharing information to indicate to the sync ref WTRU the required RB sets for S-SSB transmission to hold the initiated COT. The indication may be a bitmap with size equals to the number of RB sets within the wideband and a value of 1 is used to request S-SSB transmission within an RB set.

The Tx WTRU may resume the transmission on multiple RB sets after S-SSB transmission. The Tx WTRU may resume the sidelink data/control transmission using the initiated COT after the S-SSB transmission on the multiple RB sets. The Tx WTRU may monitor S-SSB transmission on the multiple RB sets within the S-SSB slot to determine whether sync ref WTRU is actually transmitting on the requested RB sets. The Tx WTRU may use LBT type 2 after the S-SSB transmission to resume the initiated COT. The Tx WTRU may select sub-type of LBT type 2 based on the gap between S-SSB transmission and the starting position of the Tx WTRU's transmission.

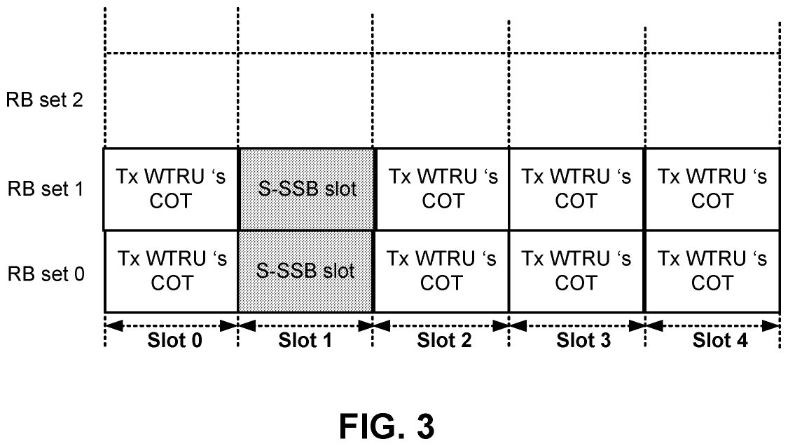

FIG. 3 depicts an example procedure of a Tx WTRU initiating a COT on two RB sets overlapping with a S-SSB slot. In FIG. 3, the Tx WTRU may be configured with a wideband that has 3 RB sets: RB set 0, RB set 1 and RB set 2. The Tx WTRU may initiate a COT for sidelink data transmission on slot 0 and using RB set 0 and RB set 1. The Tx WTRU may select a sync ref WTRU and may indicate to the selected sync ref WTRU to transmit S-SSB on RB set 0 and RB set 1. The Tx WTRU may use the COT after S-SSB transmission on RB set 0 and RB set 1.

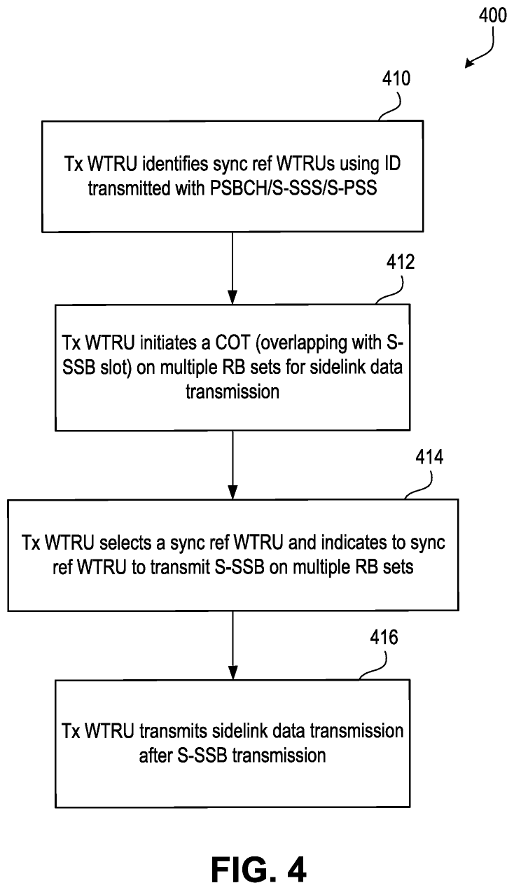

FIG. 4 depicts an example procedure 400 for a Tx WTRU identifying a sync ref WTRU and requesting S-SSB transmission on multiple RB sets. As shown in FIG. 4, the Tx WTRU identifies the sync ref WTRU and requests S-SSB transmission on multiple RB sets. The WTRU identifies neighboring sync ref WTRUs transmitting S-SSB in SL-U. The WTRU then requests identified sync Ref WTRU to transmit S-SSB on one or more RB sets within an initiated COT by the WTRU. After S-SSB transmission, the WTRU uses LBT type 2 to transmit SL data transmission on one or more RB sets that was used for S-SSB transmission.

The Sync Ref WTRU may include the Sync Ref WTRU ID in a S-SSB transmission (e.g., using an explicit indication in PSBCH and/or using S-SSS/S-PSS/PSBCH-DMRS sequence associated with WTRU ID). The Tx WTRU may monitor the S-SSB transmission within a configured frequency range and may determine the WTRU ID of one or more sync ref WTRU(s), for example, at 410. For example, the Tx WTRU may receive confirmation information that indicates the frequency range and an indication of the WTRU ID of one or more sync ref WTRU(s). At 412, the Tx WTRU may initiate a COT on one or more RB sets, for example, using LBT type 1 to transmit sidelink data transmission and/or sidelink control transmission. The Tx WTRU may determine that the COT is overlapping with S-SSB slot(s) and sidelink transmissions are still needed after the S-SSB slots. The Tx WTRU may identify the RB sets needed for transmission after S-SSB slot(s).

At 414, the Tx WTRU may select a sync ref WTRU. The Tx WTRU may indicate to the sync ref WTRU to transmit S-SSB on multiple RB sets. For example, the Tx WTRU may select a sync ref WTRU based on whether the Sync ref WTRU with highest RSRP of S-SSB, the Sync ref WTRU with WTRU ID within a pre-configured WTRU IDs, the Sync ref WTRU that is part of unicast communication with the Tx WTRU, and/or the Sync ref WTRU that is part of groupcast/broadcast communication with the Tx WTRU. The Tx WTRU may indicate to the selected sync ref WTRU that, if the Tx WTRU determines that the sync ref WTRU is “target WTRU” of a unicast/groupcast/broadcast transmission intended in the COT, the WTRU may indicate to the sync ref WTRU the RB sets to use for S-SSB transmission using SC. If the Tx WTRU determines that the Sync ref WTRU is not “target WTRU”, the Tx WTRU may request the sync ref WTRU to transmit S-SSB on multiple RB sets using broadcasted COT sharing information. At 416, the Tx WTRU may transmit sidelink data transmission after S-SSB transmission. For example, the Tx WTRU may use the LBT type 2 to transmit SL data transmission on one or more RB sets that was used for S-SSB transmission.

A Sync ref WTRU may indicate one or more used RB sets to transmit the S-SSB. For example, the sync ref WTRU configuration of S-SSB RB sets may identify the coverage level. In examples, a sync ref WTRU may be configured with different coverage requirement level. The coverage requirement level may be a target of communication range (e.g., distance from the sync ref WTRU) with a block error rate (BLER) value. For each coverage requirement level, the sync ref WTRU may transmit S-SSB during the S-SSB slot(s) with certain resources to meet the coverage requirement level. The sync ref WTRU may be configured with a number of RB sets for S-SSB transmission corresponding to a coverage requirement level.

The sync ref WTRU configuration of S-SSB RB sets may identify the synchronization source. For example, the sync ref WTRU may be configured with association between synchronization source and the number of RB set to use for S-SSB transmission. For each synchronization source, a number of RB set for S-SSB transmission may be configured, e.g., when using another sidelink WTRU as synchronization source, the sync ref WTRU should use a first number of RB set for S-SSB transmission. When using gNB as synchronization source, the sync ref WTRU may use a second number of RB set for the S-SSB transmission. When using GNSS as synchronization source, the sync ref WTRU may use a third number of RB set for S-SSB transmission.

The sync ref WTRU may determine the set of RB sets for the S-SSB transmission. The sync ref WTRU may be configured to determine the RB sets to use for S-SSB transmission in wideband operation based on one of more factors. For example, the coverage requirements of the S-SSB transmission (e.g., coverage requirement level). For example, a sync ref WTRU may be configured with multiple coverage requirement levels where each coverage requirement level may be associated with a number of RB sets to use for S-SSB transmission within S-SSB slot(s). Such configuration may be indicated using SIB information. In one example solution, sync ref WTRU may be configured with wideband operation with 3 RB sets and configured with 3 coverage levels. A first coverage level may be associated with S-SSB transmission using one RB set, second coverage level may be associated with S-SSB transmission using two RB sets and third coverage level may be associated with S-SSB transmission using three RB sets. Based on the coverage level the sync ref WTRU may be operating on, it determines the number of RB sets to use for S-SSB transmission. The sync ref WTRU determines the coverage level based on the V2X service requirements, e.g., the sync ref WTRU may have a V2X service that requires higher coverage and another V2X service that targets short distance communication.

The Sync source of the sync ref WTRU, e.g., the sync ref WTRU using gNB as synchronization source may be configured to transmit S-SSB using all the RB sets of the wideband. In another example, sync ref WTRU using GNSS as synchronization source may be configured to transmit S-SSB using one RB set of the wideband. The sync ref WTRU may be configured with an association between synchronization source and the number of RB sets to use for S-SSB transmission within S-SSB slot(s). Further, the RB set(s) reserved by other WTRUs for sidelink data/control transmission may also be part of the configuration. If the sidelink data transmission priority may be higher than a configured threshold, S-SSB may not be transmitted on the RB set. Otherwise, S-SSB may be transmitted on the RB set. The sync ref WTRU may determine the data transmission priority based on the sidelink control information (SCI) transmitted by other WTRUs. As a further example, the congestion level of the RB sets may be included, e.g., if the sync ref WTRU determines that RB set may be congested, the sync ref WTRU does not use the RB set for S-SSB transmission. Still further, the number of SL U WTRUs using an RB set may be included, e.g., if the sync ref WTRU determines that the RB set may be used by X number of SL WTRUs, the sync ref WTRU transmits S-SSB on that RB set.

The sync Ref WTRU may transmit the S-SSB using one or more previously determined RB sets. The sync ref WTRU may attempt to transmit the S-SSB on the selected RB sets and using the required LBT type (e.g., short LBT or long LBT). For example, the sync ref WTRU may use a short LBT (e.g., sensing the channel for fixed duration to determine whether the channel is idle) or use a long LBT (e.g., sensing the channel for randomly selected number of sensing slots, where the range of the random number of sensing slots depends on the channel access priority access). Upon determining the channel is idle during the sensing duration, the sync Ref WTRU may transmit S-SSB by repeating the S-SSB over the identified RB sets.

The sync Ref WTRU may indicate to SL WTRUs the RB sets used for S-SSB transmission. The sync ref WTRU may indicate to the SL WTRUs the RB sets that are used for S-SSB transmission within the S-SSB slots. In one solution, the sync ref WTRU may be configured to use sidelink control information (SCI) to indicate the RB set(s) used for S-SSB transmission within S-SSB slot(s). The indication may be a bitmap with size equal to the number of RB sets within the wideband. In another solution, the sync ref WTRU may be configured to use physical sidelink broadcast channel (PSBCH) to indicate the RB set(s) used for S-SSB transmission within S-SSB slot(s). The indication may be a bitmap with size equal to the number of RB sets within the wideband. Additionally or alternatively, the sync ref WTRU may use the S-SSS/S-PSS sequence/PSBCH-DMRS sequence to indicate the RB set(s) used for S-SSB transmission within S-SSB slot(s). The sync ref WTRU uses a S-SSS/P-SSS sequence/PSBCH DMRS sequence that is associated with a S-SSB transmission over a group of RB set(s). Such association between group of RB set(s) and S-SSS/P-SSS sequence/PSBCH DMRS sequence may be fixed in the specification.

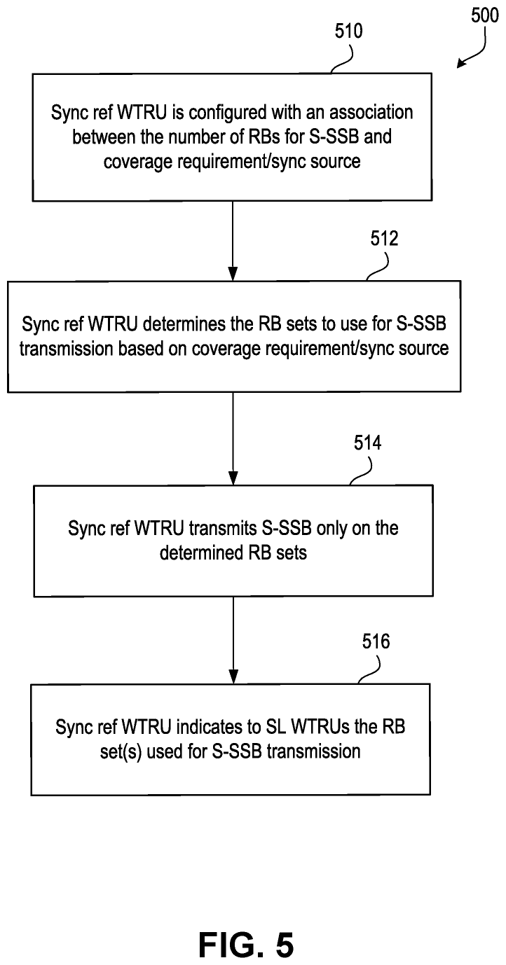

FIG. 5 depicts an example procedure 500 for a Sync ref WTRU indicating one or more used RB sets to transmit a S-SSB. In this example, a Sync ref WTRU may indicate one or more used RB sets to transmit the S-SSB. The Sync ref WTRU may receive a request to transmit S-SSB in multiple RB sets. Sync ref WTRU determines the RB sets to use for S-SSB and indicates to SL U WTRUs the set of RB sets to be used for S-SSB transmission. This enables the SL WTRU to receive the RB sets used for S-SSB and combine the transmission from different RB sets.

At 510, the Sync ref WTRU may be configured with an association between number of RB sets for S-SSB transmission and coverage requirements and/or synchronization source used to acquire the timing. At 512, the Sync ref WTRU may determine the RB sets to be used for S-SSB transmission based on: (1) coverage requirements of the S-SSB transmission, (2) the sync source of the sync ref WTRU (e.g., sync ref WTRU with gNB as sync resource may be configured to transmit S-SSB on multiple RB sets), (3) the Sync ref WTRU's buffer status, (4) the RB set(s) reserved by other WTRUs for sidelink data/control transmission, (5) the congestion level of the RB sets, and/or (6) the number of SL U WTRUs using an RB set. If the sidelink data transmission priority is higher than a configured threshold, S-SSB may not be transmitted on the RB set or the S-SSB may be transmitted on the RB set.

At 514, the Sync ref WTRU may transmit a S-SSB using the selected determined RB sets. At 516, the Sync ref WTRU may indicate to SL WTRUs the set of RB sets to be used for S-SSB using one or more of the following: (a) the SCI to indicate the used RB sets for S-SSB, (b) the PSBCH to indicate the used RB sets for S-SSB, and/or (c) using an implicit indication based on the S-SSS/S-PSS sequence/PSBCH-DMRS sequence. The sync ref WTRU may use a S-SSS/P-SSS sequence/PSBCH DMRS sequence that is associated with a S-SSB transmission over a group of RB set(s).

Below is a list of acronyms that may be used throughout the application.
ACK Acknowledgement
BLER Block Error Rate
BWP Bandwidth Part
CAP Channel Access Priority
CAPC Channel access priority class
CCA Clear Channel Assessment
CCE Control Channel Element
CE Control Element
CG Configured grant or cell group
CP Cyclic Prefix
CP-OFDM Conventional OFDM (relying on cyclic prefix)
CQI Channel Quality Indicator
CRC Cyclic Redundancy Check
CSI Channel State Information
CW Contention Window
CWS Contention Window Size
CO Channel Occupancy
DAI Downlink Assignment Index
DCI Downlink Control Information
DFI Downlink feedback information
DG Dynamic grant
DL Downlink
DM-RS Demodulation Reference Signal
DRB Data Radio Bearer
eLAA enhanced Licensed Assisted Access
FeLAA Further enhanced Licensed Assisted Access
HARQ Hybrid Automatic Repeat Request
LAA License Assisted Access
LBT Listen-Before-Talk
LTE Long Term Evolution e.g. from 3GPP LTE R8 and up
NACK Negative ACK
MCS Modulation and Coding Scheme
MIMO Multiple Input Multiple Output
NR New Radio
OFDM Orthogonal Frequency-Division Multiplexing
PHY Physical Layer
PID Process ID
PO Paging Occasion
PRACH Physical Random Access Channel
PSBCH Physical Sidelink Broadcast Channel
PSS Primary Synchronization Signal
RA Random Access (or procedure)
RACH Random Access Channel
RAR Random Access Response
RCU Radio access network Central Unit
RF Radio Front end
RLF Radio Link Failure
RLM Radio Link Monitoring
RNTI Radio Network Identifier
RO RACH occasion
RRC Radio Resource Control
RRM Radio Resource Management
RS Reference Signal
RSRP Reference Signal Received Power
RSSI Received Signal Strength Indicator
SDU Service Data Unit
SRS Sounding Reference Signal
SS Synchronization Signal
SSS Secondary Synchronization Signal
SWG Switching Gap (in a self-contained subframe)
SPS Semi-persistent scheduling
SUL Supplemental Uplink
TB Transport Block
TBS Transport Block Size
TRP Transmission/Reception Point
TSC Time-sensitive communications
TSN Time-sensitive networking
UL Uplink
URLLC Ultra-Reliable and Low Latency Communications
WBWP Wide Bandwidth Part
WLAN Wireless Local Area Networks and related technologies (IEEE 802.xx domain)
What is claimed is:

1. A wireless transmit/receive unit (WTRU) comprising:
a processor configured to:
monitor sidelink transmissions from one or more other WTRUs during a resource sensing window;
determine reserved sidelink resources prior to or after sidelink synchronization signal block (S-SSB) slots based on the monitored sidelink transmissions during the resource sensing window, wherein the S-SSB slots comprise a plurality of resource block (RB) sets; and
determine one or more other WTRUs reserving the reserved sidelink resources.

2. The WTRU of claim 1, wherein at least one RB set of the plurality of RB sets is configured as a default RB set; and wherein the processor is configured to:
determine at least one RB set other than the default RB set based on the one or more other WTRUs reserving the reserved sidelink resources in the slot before and after the S-SSB slots;
transmit the S-SSB information on the at least one RB set other than the default RB set based on at least one of the one or more other WTRUs reserving the reserved sidelink resources on a slot prior to or after the S-SSB slots; and
determine the at least one RB set other than the default RB set based on a priority associated with the reserved sidelink resources prior to or after the S-SSB slots.

3. The WTRU of claim 2, wherein the processor is configured to determine the priority associated with the reserved sidelink resources prior to or after the S-SSB slots based on sidelink control information (SCI) transmitted by the one or more other WTRUs reserving the reserved sidelink resources.

4. The WTRU of claim 24, wherein the processor is configured to determine a listen before talk (LBT) type for the S-SSB transmission on the at least one RB set other than the default RB set.

5. The WTRU of claim 4, wherein the LBT type is a long LBT type or a short LBT type.

6. The WTRU of claim 2, wherein the processor is configured to send an indication of a listen before talk (LBT) type to be used for reserved sidelink transmission to the one or more other WTRUs.

7. The WTRU of claim 6, wherein the indication to the other WTRUs is via an indication physical sidelink broadcast channel (PSBCH).

8. The WTRU of claim 2, wherein the processor is configured to monitor the sidelink transmissions during the resource sensing window to decode sidelink control information (SCI) transmitted by the one or more other WTRUs reserving the reserved sidelink resources.

9. The WTRU of claim 8, wherein the SCI indicates the reserved sidelink resources prior to or after the S-SSB slots.

10. The WTRU of claim 8, wherein the processor is configured to:
determine, based on the SCI, identification information of the one or more other WTRUs reserving the reserved sidelink resources in the slot before and after the S-SSB slots; and
determine the at least one RB set other than the default RB set based on the identification information of the one or more other WTRUs reserving the reserved sidelink resources in the slot before and after the S-SSB slots.

11. A method performed by a wireless transmit/receive unit (WTRU). the method comprising:
monitoring sidelink transmissions from one or more other WTRUs during a resource sensing window;
determining reserved sidelink resources prior to or after sidelink synchronization signal block (S-SSB) slots based on the monitored sidelink transmissions during the resource sensing window, wherein the S-SSB slots comprise a plurality of resource block (RB) sets; and
determining one or more other WTRUs reserving the reserved sidelink resources.

12. The method of claim 11, wherein at least one RB set of the plurality of RB sets is configured as a default RB set; and wherein the method further comprising:
determining at least one RB set other than the default RB set based on the one or more other WTRUs reserving the reserved sidelink resources in the slot before and after the S-SSB slots;
transmitting the S-SSB information on the at least one RB set other than the default RB set based on at least one of the one or more other WTRUs reserving the reserved sidelink resources on a slot prior to or after the S-SSB slots; and
determining the at least one RB set other than the default RB set based on a priority associated with the reserved sidelink resources prior to or after the S-SSB slots.

13. The method of claim 12, the method further comprising:
determining the priority associated with the reserved sidelink resources prior to or after the S-SSB slots based on sidelink control information (SCI) transmitted by the one or more other WTRUs reserving the reserved sidelink resources.

14. The method of claim 12, the method further comprising:
determining a listen before talk (LBT) type for the S-SSB transmission on the at least one RB set other than the default RB set.

15. The method of claim 14, wherein the LBT type is a long LBT type or a short LBT type.

16. The method of claim 12, the method further comprising:
sending an indication of a listen before talk (LBT) type to be used for reserved sidelink transmission to the one or more other WTRUs.

17. The method of claim 16, wherein the indication to the other WTRUs is via an indication physical sidelink broadcast channel (PSBCH).

18. The method of claim 12, the method further comprising:
monitoring the sidelink transmissions during the resource sensing window to decode sidelink control information (SCI) transmitted by the one or more other WTRUs reserving the reserved sidelink resources.

19. The method of claim 18, wherein the SCI indicates the reserved sidelink resources prior to or after the S-SSB slots.

20. The method of claim 18, the method further comprising:
determining, based on the SCI, identification information of the one or more other WTRUs reserving the reserved sidelink resources in the slot before and after the S-SSB slots; and
determining the at least one RB set other than the default RB set based on the identification information of the one or more other WTRUs reserving the reserved sidelink resources in the slot before and after the S-SSB slots.
